(19) United States
(12) Patent Application Publication
(10) Pub. No.: US 2021/0316747 A1
(43) Pub. Date: Oct. 14, 2021

(54) Animal Collision Alert Assembly

(71) Applicant: Michael Klein, Joliet, IL (US)

(72) Inventor: Michael Klein, Joliet, IL (US)

(21) Appl. No.: 16/847,921

(22) Filed: Apr. 14, 2020

(51) Int. Cl. B60W 50/14; G06K 9/00; G08G 1/16

(52) U.S. Cl. CPC B60W 50/14; B60W 2050/143; G08G 1/16; G06K 9/00791

(57) ABSTRACT

An animal collision alert assembly includes a housing that is positionable within a vehicle. A transceiver is positioned within the housing and the transceiver receives data pertaining to a prediction of the location of animals with respect to a roadway. A light detection and ranging (LIDAR) unit is coupled to the housing to survey the area in front of the vehicle. A thermal imaging camera is coupled to the housing to record a thermal image of the area in front of the vehicle. A display is coupled to the housing and the display renders a map showing the predicted location of the animals with respect to the roadway on which the vehicle is driving. A speaker is coupled to the housing and the speaker emitting an audible alert to alert the driver to a potential collision with the animal.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to collision alert devices and more particularly pertains to a new collision alert device for alerting a driver of a potential collision with an animal.

### (2) Description of Related Art Including Information Disclosed Under 37 CFR 1.97 and 1.98

The prior art relates to collision alert devices including an environmental control system for a vehicle that includes a customizable touch screen. The prior art discloses a variety of collision warning systems that include roadside animal sensors that transmit an alert signal to vehicles for collision warning. The prior art also discloses an animal detection system for detecting an animal in proximity to a vehicle. The prior art also discloses a variety of collision avoidance systems that include object detection and an automatically actuated braking system.

### BRIEF SUMMARY OF THE INVENTION

An embodiment of the disclosure meets the needs presented above by generally comprising a housing that is positionable within a vehicle. A transceiver is positioned within the housing and the transceiver receives data pertaining to a prediction of the location of animals with respect to a roadway. A light detection and ranging (LIDAR) unit is coupled to the housing to survey the area in front of the vehicle. A thermal imaging camera is coupled to the housing to record a thermal image of the area in front of the vehicle. A display is coupled to the housing and the display renders a map showing the predicted location of the animals with respect to the roadway on which the vehicle is driving. A speaker is coupled to the housing and the speaker emitting an audible alert to alert the driver to a potential collision with the animal.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of an animal collision alert assembly according to an embodiment of the disclosure.

FIG. 2 is a front in-use view of an embodiment of the disclosure.

FIG. 3 is a back view of an embodiment of the disclosure.

FIG. 4 is a perspective in-use view of an embodiment of the disclosure.

FIG. 5 is a schematic view of an embodiment of the disclosure.

### DETAILED DESCRIPTION OF THE INVENTION

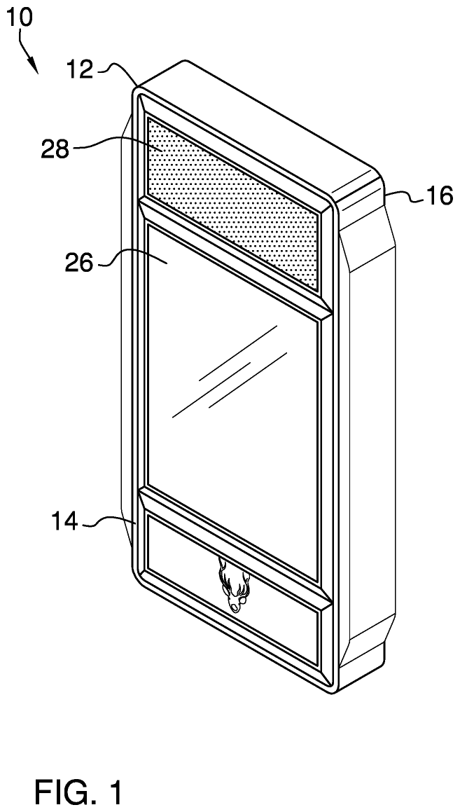

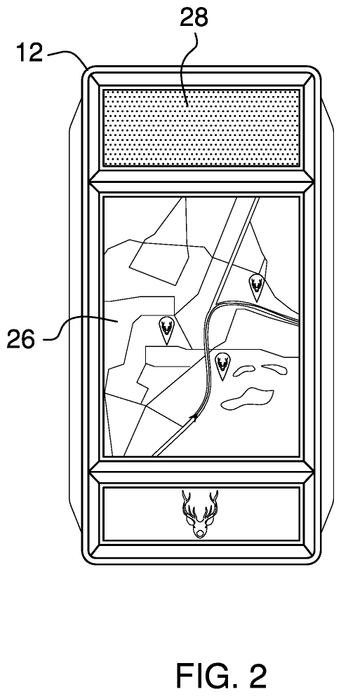

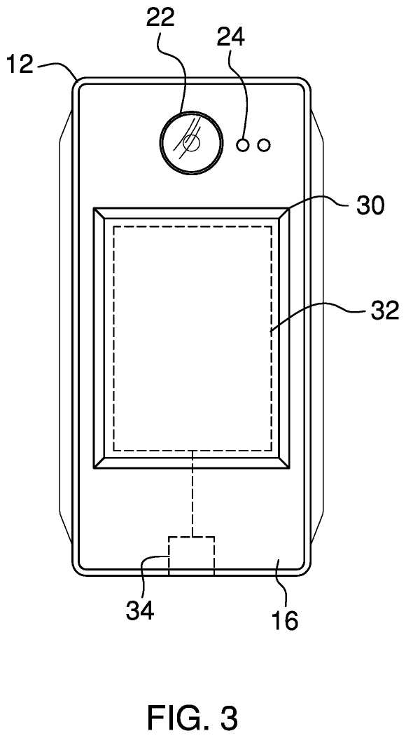

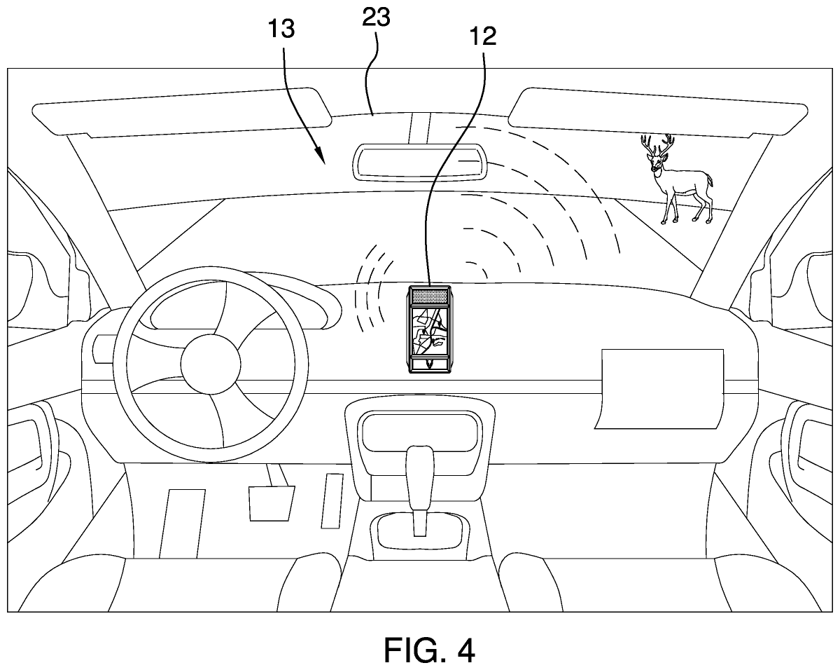

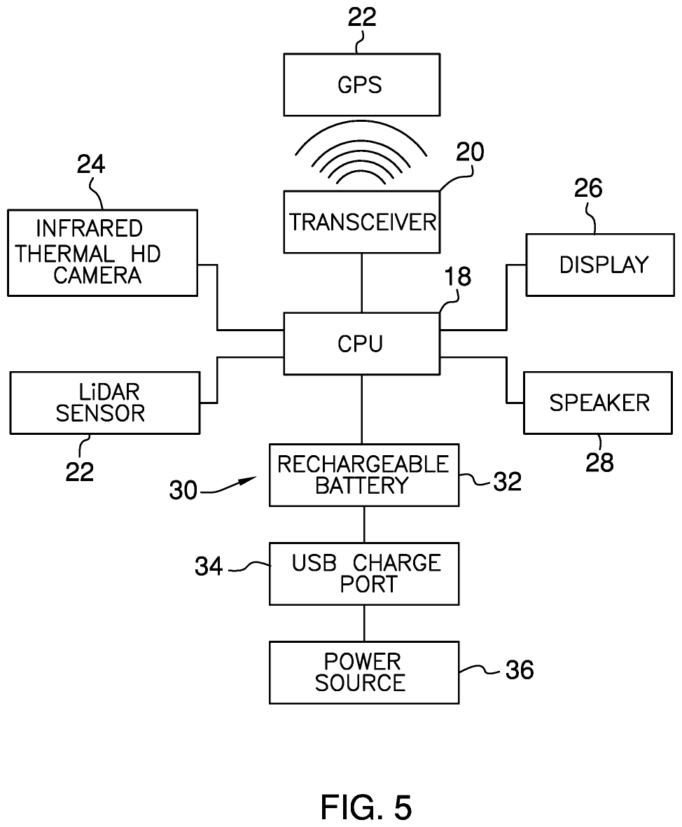

With reference now to the drawings, and in particular to FIGS. 1 through 5 thereof, a new collision alert device embodying the principles and concepts of an embodiment of the disclosure and generally designated by the reference numeral 10 will be described.

As best illustrated in FIGS. 1 through 5, the animal collision alert assembly 10 generally comprises a housing 12 that is positionable within a vehicle 13 such that the housing 12 is visible to a user. The vehicle may be a passenger vehicle, a cargo vehicle or any other motorized vehicle that is driven on public roadways. The housing 12 has a front wall 14 and a back wall 16, and the housing 12 is positioned on a dashboard of the vehicle 13 having the back wall 16 directed toward a windshield of the vehicle 13 and having the front wall 14 directed toward a driver of the vehicle 13.

A control circuit 18 is positioned within the housing 12 and the control circuit 18 receives an alert input. A transceiver 20 is positioned within the housing 12 and the transceiver 20 is in wireless communication with a global positioning system 22 (GPS). In this way the transceiver 20 receives data pertaining to a prediction of the location of animals with respect to a roadway. The transceiver 20 is electrically coupled to the control circuit 18 and the transceiver 20 may comprise a radio frequency transceiver 20 or the like. The transceiver 20 may receive data from various state level Departments of Natural Resources and other agencies that monitor herd population and herd movement of indigenous animals, such as white tailed deer, elk and other animals that are commonly struck on public roads and highways.

A light detection and ranging (LIDAR) unit 22 is coupled to the housing 12 to emit a beam of laser light outwardly therefrom. The LIDAR unit 22 is directed toward a windshield 23 of the vehicle 13 to survey the area in front of the vehicle 13. The LIDAR is electrically coupled to the control circuit 18 and the control circuit 18 receives the alert input when the LIDAR detects an animal that could potentially move in front of the vehicle 13. The LIDAR unit 22 is positioned on the back wall 16 of the housing 12 and the LIDAR unit 22 may be a LIDAR unit 22 of any conventional design.

A thermal imaging camera 24 is coupled to the housing 12 to record a thermal image of the area in front of the vehicle 13. The thermal imaging camera 24 is electrically coupled to the control circuit 18 and the thermal imaging camera 24 is positioned on the back wall 16 of the housing 12. The thermal imaging camera 24 may comprise an infrared camera or any other type of electronic camera that can render thermal imaging. A display 26 is coupled to the housing 12 such that the display 26 is visible to the driver. The display 26 displays indicia comprising a map showing the predicted location of the animals with respect to the roadway on which the vehicle 13 is driving. Moreover, the display 26 is electrically coupled to the control circuit 18, the display 26 is positioned on the front wall 14 of the housing 12 and the display 26 may comprise an LED or other type of electronic display.

A speaker 28 is coupled to the housing 12 and the speaker 28 emits an audible alert when the LIDAR unit 22 detects the animal. In this way the speaker 28 alerts the driver to a potential collision with the animal. The speaker 28 is electrically coupled to the control circuit 18 and the speaker 28 is turned on when the control circuit 18 receives the alert input. Moreover, the speaker 28 is positioned on the front wall 14 of the housing 12 and the speaker 28 may comprise an electronic speaker of any conventional design. The control circuit 18 may be in electrical communication with an electrical system of the vehicle 13, possibly through a wireless connection via the transceiver 20 or through a wired connection with the OBD port in the vehicle 13. In this way the control circuit 18 may be able to actuate the braking system of the vehicle 13, or decelerate the vehicle 13, if the control circuit 18 detects that the driver has not responded to the impending collision. Additionally, each of the control circuit 18, transceiver 20, LIDAR unit 22, thermal imaging camera 24, display 26 and speaker 28 may be integrated into the vehicle 13 during the manufacturing process of the vehicle 13.

A power supply 30 is coupled to the housing 12 and the power supply 30 is electrically coupled to the control circuit 18. The power supply 30 comprises at least one rechargeable battery 32 that is positioned within the housing 12. The at least one battery 32 is electrically coupled to the control circuit 18. The power supply 30 includes a charge port 34 that is recessed into the housing 12 and the charge port 34 is electrically coupled to the at least one rechargeable battery 32. The charge port 34 receives a charge cord that is electrically coupled to a power source 36 for charging the at least one rechargeable battery 32.

In use, the transceiver 20 receives continually updated data with respect to the possible location of animals with respect to the road on which the vehicle 13 is driven. Additionally, the display 26 displays not only GPS mapping information, but also the possible location of herds of animals with respect to the roadway on which the vehicle 13 id driving. The LIDAR unit 22 and the thermal imaging camera 24 continuously monitor the area in front of the vehicle 13 while the vehicle 13 is being driven. The speaker 28 emits the audible alarm when the either the LIDAR unit 22 or the thermal imaging camera 24 detects an animal on or near the roadway. In this way the driver is notified to take evasive action in order to avoid striking the animal.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An animal collision alert assembly for warning a driver of an imminent animal collision, said assembly comprising:
a housing being positionable within a vehicle wherein said housing is configured to be visible to a user;
a transceiver being positioned within said housing, said transceiver being in wireless communication with a global positioning system (GPS) wherein said transceiver is configured to receive data pertaining to a prediction of the location of animals with respect to a roadway;
a light detection and ranging (LIDAR) unit being coupled to said housing wherein said LIDAR unit is configured to emit a beam of laser light outwardly therefrom, said LIDAR unit being directed toward a windshield of the vehicle wherein said LIDAR is configured to survey the area in front of the vehicle;
a thermal imaging camera being coupled to said housing wherein said thermal imaging camera is configured to record a thermal image of the area in front of the vehicle;
a display being coupled to said housing wherein said display is configured to be visible to the driver, said display displaying indicia comprising a map showing the predicted location of the animals with respect to the roadway on which the vehicle is driving; and
a speaker being coupled to said housing, said speaker emitting an audible alert when said LIDAR unit detects the animal wherein said speaker is configured to alert the driver to a potential collision with the animal.

2. The assembly according to claim 1, further comprising a control circuit being positioned within said housing, said control circuit receiving an alert input, said transceiver being electrically coupled to said control circuit, said display being electrically coupled to said control circuit.

3. The assembly according to claim 2, wherein said LIDAR is electrically coupled to said control circuit, said control circuit receiving said alert input when said LIDAR detects an animal that could potentially move in front of the vehicle, said LIDAR unit being positioned on a back wall of said housing.

4. The assembly according to claim 2, wherein said thermal imaging camera is electrically coupled to said control circuit, said thermal imaging camera being positioned on a back wall of said housing.

5. The assembly according to claim 2, wherein said speaker is electrically coupled to said control circuit, said speaker being turned on when said control circuit receives said alert input, said speaker being positioned on said front wall of said housing.

6. The assembly according to claim 2, further comprising a power supply being coupled to said housing, said power supply being electrically coupled to said control circuit, said power supply comprising:
at least one rechargeable battery being positioned within said housing, said at least one battery being electrically coupled to said control circuit; and
a charge port being recessed into said housing, said charge port being electrically coupled to said at least one rechargeable battery, said charge port receiving a charge cord being electrically coupled to a power source for charging said at least one rechargeable battery.

7. An animal collision alert assembly for warning a driver of an imminent animal collision, said assembly comprising:
a housing being positionable within a vehicle wherein said housing is configured to be visible to a user, said housing having a front wall and a back wall, said housing being positioned on a dashboard of the vehicle having said back wall being directed toward a windshield of the vehicle and having said front wall being directed toward a driver of the vehicle;
a control circuit being positioned within said housing, said control circuit receiving an alert input;
a transceiver being positioned within said housing, said transceiver being in wireless communication with a global positioning system (GPS) wherein said transceiver is configured to receive data pertaining to a prediction of the location of animals with respect to a roadway, said transceiver being electrically coupled to said control circuit;
a light detection and ranging (LIDAR) unit being coupled to said housing wherein said LIDAR unit is configured to emit a beam of laser light outwardly therefrom, said LIDAR unit being directed toward a windshield of the vehicle wherein said LIDAR is configured to survey the area in front of the vehicle, said LIDAR being electrically coupled to said control circuit, said control circuit receiving said alert input when said LIDAR detects an animal that could potentially move in front of the vehicle, said LIDAR unit being positioned on said back wall of said housing;
a thermal imaging camera being coupled to said housing wherein said thermal imaging camera is configured to record a thermal image of the area in front of the vehicle, said thermal imaging camera being electrically coupled to said control circuit, said thermal imaging camera being positioned on said back wall of said housing;
a display being coupled to said housing wherein said display is configured to be visible to the driver, said display displaying indicia comprising a map showing the predicted location of the animals with respect to the roadway on which the vehicle is driving, said display being electrically coupled to said control circuit, said display being positioned on said front wall of said housing;
a speaker being coupled to said housing, said speaker emitting an audible alert when said LIDAR unit detects the animal wherein said speaker is configured to alert the driver to a potential collision with the animal, said speaker being electrically coupled to said control circuit, said speaker being turned on when said control circuit receives said alert input, said speaker being positioned on said front wall of said housing; and
a power supply being coupled to said housing, said power supply being electrically coupled to said control circuit, said power supply comprising:
at least one rechargeable battery being positioned within said housing, said at least one battery being electrically coupled to said control circuit; and
a charge port being recessed into said housing, said charge port being electrically coupled to said at least one rechargeable battery, said charge port receiving a charge cord being electrically coupled to a power source for charging said at least one rechargeable battery.
